(19) United States
(12) Patent Application Publication
(10) Pub. No.: US 2025/0046873 A1
(43) Pub. Date: Feb. 6, 2025

(54) ELECTROLYTE SOLUTION AND SECONDARY BATTERY COMPRISING THE SAME

(71) Applicant: SEOUL NATIONAL UNIVERSITY R&DB FOUNDATION

(72) Inventors: Jong Woo LIM, Seoul (KR); Jun Yeob MOON, Seoul (KR)

(21) Appl. No.: 18/289,932

(22) PCT Filed: Nov. 4, 2022
(86) PCT No.: PCT/KR2022/017205

§ 371 Date: Nov. 8, 2023

(30) Foreign Application Priority Data
Sep. 8, 2022 (KR) 10-2022-0114069

(51) Int. Cl. H01M 10/0569; H01M 10/0568

(52) U.S. Cl. CPC H01M 10/0569; H01M 10/0568; H01M 2300/0037

(57) ABSTRACT

Disclosed herein an electrolyte solution and secondary battery comprising the same, the electrolyte solution comprises: a lithium salt; a first solvent; and a second solvent, in which when Lewis basicities of the Kamlet-Taft parameters of the first solvent and the second solvent are represented by β₁ and β₂, respectively, the β₁ is 0.40 or more, and the β₂ is 0.20 or less.

### TECHNICAL FIELD

The present invention relates to an electrolyte solution and secondary battery comprising the same.

### BACKGROUND ART

With the rapid development of the electrical, electronic, communication and computer industries, the demand for a secondary battery with high performance and high reliability is increasing rapidly.

The secondary battery having a stacked or wound structure of an electrode assembly including a cathode, an anode, and a separator interposed therebetween, in which the electrode assembly is embedded in a battery case and an electrolyte solution is injected therein.

Recently, in order to implement the secondary battery with high capacity and high energy density, various studies have been conducted on lithium metal battery (LMB) using lithium metal as an anode active material.

The anode comprising lithium metal used in the lithium metal battery is a material with a large volume-to-capacity or mass-to-capacity ratio, which is an efficient material for reducing the volume or weight of the battery, and there is an advantage in that a high battery voltage can be obtained as the reduction potential is the lowest among the anode materials of the lithium secondary battery.

However, due to the high chemical/electrochemical reactivity of lithium metal, the lithium metal battery may easily react with an electrolyte, impurity, and lithium salt, etc. to form a solid electrolyte interphase (SEI) layer that does not have electrochemical activity on a surface of an electrode, and such a solid electrolyte interphase layer that does not have electrochemical activity may cause a localized difference in current density to form a lithium dendrite on a surface of the lithium metal. In addition, the lithium dendrite may increase a contact area of the lithium metal with an electrolyte solution, thereby increasing reactivity, which may cause a decrease in the stability of the secondary battery, as well as a decrease in the capacity, coulombic efficiency, and life characteristics of the secondary battery.

As a solution for the problems above, efforts have been made to form a solid electrolyte interface with strong electrochemical activity on the anode comprising the lithium metal at the beginning of the charge and discharge. In addition, in order to efficiently improve the performance of the secondary battery, attempts to form an inorganic-based solid electrolyte interface rather than an organic-based interface on the surface of the anode comprising the lithium metal have been mainstreamed. In this regard, research is still needed to further improve the performance of the secondary battery.

### DOCUMENTS OF RELATED ART

### Patent Documents

(Patent Document 1) Korean Patent Application Laid-Open No. 2017-0028391

### Non-Patent Document

(Non-Patent Document 1) Ditchfield, R et al., The Journal of Chemical Physics 54, 724-728 (1971)

### DISCLOSURE

### Technical Problem

The present invention is aimed at solving the problems in the related art described above, and directed to providing an electrolyte solution which is capable of establishing a solvation environment in which negative ions exist around lithium ions (Li⁺) in the electrolyte solution, forming a mechanically strong inorganic-based solid electrolyte interphase on an anode comprising a lithium metal, and further securing the stability of a secondary battery even under long-term charge and discharge, as well as improving life characteristics by comprising two or more species of cosolvents comprising a first solvent and a second solvent, in which Lewis basicity of Kamlet-Taft parameters of the first solvent and the second solvent satisfy a specific value, respectively.

### Technical Solution

According to an embodiment of the present invention, there is provided an electrolyte solution comprising: a lithium salt; a first solvent; and a second solvent, in which Lewis basicity of Kamlet-Taft parameters of a first solvent and a second solvent are represented by β₁ and β₂, respectively, in which case the β₁ is 0.40 or more, and the β₂ is 0.20 or less.

According to an embodiment of the present invention, there is provided a secondary battery comprising: an anode; a cathode; a separator interposed between the cathode and the anode, and an electrolyte solution, in which the electrolyte solution comprises a lithium salt; a first solvent; and a second solvent, and when Lewis basicities of Kamlet-Taft parameters of a first solvent and a second solvent are represented by β₁ and β₂, respectively, in which the β₁ may be 0.40 or more, and the β₂ may be 0.20 or less.

### Advantageous Effects

The electrolyte solution according to the present invention can form an inorganic-based solid electrolyte interphase with strong electrochemical activity on an anode comprising a lithium metal, so that the delamination of the solid electrolyte interphase can be minimized even with large volume changes during charging and discharging of the secondary battery, thereby further enhancing the stability of the anode and enabling a long-term stable operation of the anode.

In addition, the secondary battery according to the present invention may further improve the life characteristics by comprising the electrolyte solution having the characteristics above.

### Modes of the Invention

Hereinafter, the present invention will be described in detail with reference to embodiments. The embodiments are not limited to those disclosed hereinafter, but may be modified in various forms without changing the subject matter of the present invention.

In the specification, unless explicitly described to the contrary, the word of “comprise” and its variations, such as “comprises”, “comprising”, “cotain”, “containing”, “include” or “including”, will be understood to imply the inclusion of stated constituent elements, not the exclusion of any other constituent elements.

In addition, all numerical ranges for property values, dimensions, etc. of a constituent element described in this specification should be understood to be expressed in all cases by the term “approximately” unless otherwise noted.

### [Electrolyte Solution]

An electrolyte solution, according to an embodiment of the present invention, comprises: a lithium salt; a first solvent; and a second solvent, in which Lewis basicity of the Kamlet-Taft parameters of the first solvent and the second solvent are represented by β₁ and β₂, respectively, in which case the β₁ is 0.40 or more, and the β₂ is 0.20 or less.

In general, the electrolyte solution is a medium that enables the transfer of lithium ions (Li⁺) between a cathode and an anode, enabling the reversible charge and discharge of lithium ions. In addition, since the electrolyte solution is in direct contact with the cathode and anode and a chemical reaction occurs accordingly, the selection of the electrolyte solution becomes an important variable for surface stabilization of the cathode and anode, which may have a significant impact on the performance of the secondary battery.

The electrolyte solution comprises a lithium salt, which serves as a pathway for the lithium ions (Li⁺) to move through, and a solvent, which dissolves or dissociates the lithium salt and helps the ions move smoothly. In this case, the solvent surrounds the lithium ion (Li⁺) inside the electrolyte solution, resulting in solvation.

Here, the term “solvation” means a phenomenon in which a lithium salt is dissolved by a solvent to form lithium ions (Li⁺), and the solvent surrounds the lithium ions (Li⁺) by attraction.

In contrast, the term “non-solvation” means that a lithium salt is not dissolved by a solvent in the electrolyte solution, and no solvation with lithium ions (Li⁺) occurs.

When the electrolyte solution comprises only the solvent (e.g., the first solvent) that dissolves the lithium salt well and solvates the lithium ions (Li⁺), since the solvent that is an organic matter is mainly solvated around the lithium ions (Li⁺), a solid electrolyte solution interphase (SEI) layer based on a weak organic material is formed, which is easily broken during the repeated charge and discharge process. In this process, the solid electrolyte interphase layer causes a localized difference in current density, resulting in the formation of lithium dendrite on the surface of the anode, which may not only make it difficult to secure stability in case of repeated charge and discharge, but also limit the improvement of the life characteristics of the secondary battery.

In the present invention, as two or more species of mixed solvents comprising the first solvent and the second solvent are comprised, and β₁ and β₂ of the Kamlet-Taft parameters of the first solvent and the second solvent, which represent the Lewis basicity, respectively, satisfy a specific range, the extent of solvation of lithium ions (Li⁺) in the electrolyte solution can be controlled, and an inorganic-based solid electrolyte interphase with strong electrochemical activity can be formed on an anode comprising a lithium metal. Further, the stability of the secondary battery can be secured even under long-term charge and discharge, and the life characteristics can be improved. Specifically, the secondary battery has excellent life characteristics such as a ratio of the discharge capacity in a specific cycle to the discharge capacity in a first cycle of the secondary battery, and lasting for more than a specific cycle with a 0.2 C charge and discharge.

Specifically, in the electrolyte solution of the present invention, by comprising the first solvent in which the Bi satisfies 0.4 or more, the lithium salt is well dissolved to facilitate the smooth movement of the lithium ions (Li⁺), by comprising the second solvent in which the β₂ satisfies 0.2 or less, the second solvent serves as a cosolvent for the first solvent, further stabilizing the solvation of the lithium ions (Li⁺), so that a mechanically strong inorganic-based stable solid electrolyte interphase layer may be formed, and minimizing the formation of lithium dendrites on the anode surface, which may help to ensure stable charge and discharge. In this case, the stability of the anode, especially the anode comprising lithium metal, may be further enhanced to enable long-term operation of the anode.

According to an embodiment of the present invention, the first solvent and the second solvent having a specific level of β₁ and β₂ of the Kamlet-Taft parameters may be selected and used to achieve a targeted level of solvation of lithium ions.

The Kamlet-Taft parameter is a parameter obtained from a difference in absorption wavelengths by irradiating a specific wavelength of light in a solvent using a UV spectrometer.

The Lewis basicity β of the Kamlet-Taft parameters, for example, is a basicity calculated using a maximum absorption wavelength (λₘₐₓ) by adding 4-nitroaniline and N,N-diethyl-4-nitroaniline to each of the first solvent and the second solvent using a UV spectrometer, which may be a measure of the extent of solvation of the first solvent and the second solvent for lithium ions (Li⁺).

Specifically, in the electrolyte solution, the lithium ion (Li⁺) serves as an electron-demanding Lewis acid, and the first solvent and the second solvent serve as electron-giving Lewis bases, so that, through the Kamlet-Taft parameter, a difference in the maximum absorption wavelength may appear depending on the extent to which the first solvent and the second solvent each bind with the lithium ion (Li⁺). Therefore, through the maximum absorption wavelength, the extent to which the first solvent and the second solvent bind with the lithium ion (Li⁺), respectively, that is, the extent of solvation for the lithium ion (Li⁺), can be determined.

In an embodiment of the present invention, the Lewis basicity of the Kamlet-Taft parameters may be obtained by measuring the absorbance in the wavelength region from approximately 300 to 500 nm using, for example, a Shimadzu UV-2600 spectrometer.

Specifically, the maximum absorption wavelength λₘₐₓ (4) may be obtained by adding 4-nitroaniline to a concentration of approximately 1×10⁻⁴ M, and the maximum absorption wavelength λmax (n) may be obtained by adding N,N-diethyl-4-nitroaniline to a concentration of 1×10⁻⁴ M, to a solvent (the first solvent or the second solvent) in which the Lewis basicity of the Kamlet-Taft parameters is to be measured.

Then, after converting the above λₘₐₓ₍₄₎ and λₘₐₓ₍ₙ₎ to a unit of kK (kilokaiser, 1 kK=1000 cm⁻¹), respectively, the Lewis basicity β may be obtained using Equations 1-1 and 1-2 below.

$${λ}_{max ( N ) (} kK ) = {λ}_{max ( n ) (} kK ) \times 1.035 + 2.64 \qquad [ Equation 1 - 1 ]$$

In Equation 1-1 above,
the λₘₐₓ₍ₙ₎ is the maximum absorption wavelength (λₘₐₓ₍ₙ₎) measured at a concentration of 1×10⁻⁴ M of a mixed solution of the solvent above and N,N-diethyl-4-nitroaniline, and
1.035 and 2.64 above are a slope and a y-intercept obtained by first-order linear regression of λₘₐₓ₍₄₎ and λₘₐₓ₍ₙ₎, in which the maximum absorption wavelength (λₘₐₓ₍₄₎) is obtained by adding 4-nitroaniline to a concentration of approximately 1×10⁻⁴ M to various types of nonpolar solvents, and the maximum absorption wavelength (λₘₐₓ₍ₙ₎) is obtained by adding N,N-diethyl-4-nitroaniline to a concentration of 1×10⁻⁴ M to various types of nonpolar solvents, respectively.

$$β = \frac{λ max ( N ) - λ max ( 4 )}{2.8} \qquad [ Equation 1 - 2 ]$$

In Equation 1-2 above,
the λ^{max(N)} is as defined in Equation 1-1 above,
the λₘₐₓ₍₄₎ is the maximum absorption wavelength (λₘₐₓ₍ₙ₎) measured at a concentration of 1×10⁻⁴ M of a mixed solution of the solvent above and 4-nitroaniline.

For example, by adding 4-nitroaniline and N,N-diethyl-4-nitroaniline to the first solvent, respectively, the respective maximum absorption wavelengths may be obtained, and the Lewis basicity Bi of the first solvent may be obtained by using Equations 1-1 and 1-2 above.

In addition, by adding 4-nitroaniline and N,N-diethyl-4-nitroaniline to the second solvent, respectively, the respective absorbance wavelengths may be obtained, and the Lewis basicity β₂ of the second solvent may be obtained using Equations 1-1 and 1-2 above.

According to an embodiment of the present invention, by comprising a mixed solvent of two different Lewis basicities in the Kamlet-Taft parameter, in which β₁, representing the Lewis basicity of the first solvent, is 0.40 or more, and β₂, representing the Lewis basicity of the second solvent, is 0.20 or less, it is possible to create a solvation environment in which negative ions are distributed around the lithium ions, thereby further improving the performance, especially the life characteristics, of the secondary battery.

Hereinafter, each component of the electrolyte solution of the present invention will be described in detail.

### Lithium Salt

The electrolyte solution according to an embodiment of the present invention may comprise a lithium salt.

The lithium salt may serve as a pathway for the movement of lithium ions (Li⁺).

The lithium salt is not particularly limited in the present invention and may be used without limitation as long as it is commonly available in the electrolyte solution for the secondary battery.

Specifically, the lithium salt may comprise one or more species selected from the group consisting of LiPF₆, LiAsF₆, LIFSI, LiTFSI, LiCF₃SO₃, LIN (CF₃SO₂)₂, LiBF₄, LiBF₆, LiSbF₆, LIN(C₂F₅SO₂)₂ and LiSO₃CF₃. More specifically, the lithium salt may comprise one or more species selected from the group consisting of LiPF₆, LiAsF₆, LIFSI, LiTFSI, and LiBF₄. When the lithium salt is used, the lithium salt may be easily dissolved and dissociated in the first solvent, thereby further improving the movement, solubility and chemical stability of ions.

Specifically, based on a total volume of the first solvent and the second solvent, a concentration of the lithium salt may be, for example, 1 to 8 mol, for example, 1 to 7 mol, for example, 1 to 6 mol, for example, 1 to 5 mol, for example, 2 to 5 mol, for example, 1 to 4 mol, for example, 2 to 4 mol, or for example, 1 to 3 mol. When the concentration of the lithium salt is less than the range above, it may be difficult to secure ionic conductivity suitable for driving the secondary battery, and when the concentration of the lithium salt exceeds the range above, the viscosity of the electrolyte solution may increase, which may reduce the mobility of lithium ions (Li⁺), and the decomposition reaction of the lithium salt itself may increase, which may reduce the performance of the secondary battery.

### First Solvent

The electrolyte solution according to an embodiment of the present invention may comprise the first solvent.

The first solvent may serve to dissolve the lithium salt well, allowing the lithium ions (Li⁺) to move smoothly.

In the electrolyte solution according to an embodiment of the present invention, the first solvent may have the β₁ of the Kamlet-Taft parameters representing Lewis basicity, for example 0.40 or more, for example 0.45 or more, for example 0.50 or more, for example 0.55 or more, or for example 0.60 or more. Specifically, the β₁ may be, for example, 0.45 or more to 1.00 or less, for example, 0.50 or more to 1.00 or less, for example, 0.55 or more to 1.00 or less, for example, 0.55 or more to 0.90 or less, for example, 0.55 or more to 0.80 or less, for example, 0.55 or more to 0.75 or less, or for example, 0.55 or more to 0.70 or less. When the β₁ satisfies the range above, the first solvent may dissolve the lithium salt well, further promoting the smooth movement of lithium ions (Li⁺).

The first solvent may comprise, for example, one or more species selected from the group consisting of an ether-based solvent, an ester-based solvent, a linear carbonate-based solvent, a cyclic carbonate-based solvent, and an amide-based solvent.

The ether-based solvent may comprise, for example, one or more species selected from the group consisting of dimethyl ether, diethyl ether, dipropyl ether, methylethyl ether, methylpropyl ether, ethylpropyl ether, dimethoxyethane (e.g., 1,2-dimethoxyethane), diethoxyethane, methoxyethoxyethane, diethylene glycol dimethyl ether, diethylene glycol diethyl ether, diethylene glycol methylethyl ether, triethylene glycol dimethyl ether, triethylene glycol diethyl ether, triethylene glycol methylethyl ether, tetraethylene glycol dimethyl ether, tetraethylene glycol diethyl ether, tetraethylene glycol methylethyl ether, polyethylene glycol dimethyl ether, polyethylene glycol diethyl ether, polyethylene glycol methylethyl ether, 1,3-dioxolane, tetrahydrofuran, and 2-methyltetrahydrofuran, but is not limited thereto.

The ester-based solvent may comprise one or more species selected from the group consisting of methyl acetate, ethyl acetate, propyl acetate, γ-butyrolactone, γ-valerolactone, γ-caprolactone, σσ-valerolactone, and ε-caprolactone, but is not limited thereto.

The linear carbonate-based solvent may comprise one or more species selected from the group consisting of dimethyl carbonate (DMC), diethyl carbonate (DEC), dipropyl carbonate (DPC), ethyl methyl carbonate (EMC), methyl propyl carbonate (MPC), and ethyl propyl carbonate (EPC), but is not limited thereto.

In addition, the cyclic carbonate-based solvent may comprise one or more species selected from the group consisting of ethylene carbonate (EC), propylene carbonate (PC), 1,2-butylene carbonate, 2,3-butylene carbonate, 1,2-pentylene carbonate, 2,3-pentylene carbonate, vinylene carbonate, vinylethylene carbonate, and halides thereof, but is not limited thereto.

In addition, the halides comprise, for example, fluoroethylene carbonate (FEC) and the like, but are not limited thereto.

The amide-based solvent may comprise one or more species selected from the group consisting of N-methyl-2-pyrrolidone (NMP), dimethylacetamide (DMAC), and dimethylformamide (DMF), but is not limited thereto.

When the electrolyte solution comprises the first solvent, the lithium salt may be well dissolved to further promote the smooth movement of lithium ions (Li⁺), which may be advantageous for improving the performance of the secondary battery.

### Second Solvent

The electrolyte solution according to an embodiment of the present invention may comprise the second solvent.

The second solvent serves as a cosolvent for the first solvent, and the Kamlet-Taft parameter thereof is smaller than that of the first solvent. Accordingly, the second solvent limits the solvation zone of the first solvent beyond the solvation zone (solvation sheath) of lithium ions (Li⁺), allowing the negative ions to participate in the solvation of lithium ions (Li⁺). This enables the creation of a mechanically strong inorganic-based stable solid electrolyte interphase layer and minimizes the formation of lithium dendrites on the anode surface, resulting in a relatively stable lithium anode over sustained charge and discharge, and ultimately, further improving the performance of the secondary battery.

In order to achieve these properties, it may be very important to adjust the β₂, which represents the Lewis basicity of the Kamlet-Taft parameters of the second solvent, to have a specific value.

Specifically, in the electrolyte solution, the β₂ may be, for example, 0.20 or less, for example, 0.19 or less, or for example, 0.18 or less. Specifically, the β₂ may be, for example, −0.30 or more to 0.20 or less, for example, −0.25 or more to 0.20 or less, for example, −0.20 or more to 0.20 or less, for example, −0.10 or more to 0.20 or less, for example, 0 or more to 0.20 or less, for example, more than 0 to 0.20 or less, for example, 0.01 or more to 0.20 or less, for example, 0.02 or more to 0.20 or less, for example, 0.10 or more to 0.20 or less, for example, 0.10 or more to 0.20 or less, for example, 0.12 or more to 0.19 or less, or for example, 0.12 or more to 0.18 or less. When the β₂ satisfies the numerical range above, the solvation structure for which the present invention is aimed can be maintained, and a mechanically strong inorganic-based solid electrolyte interphase can be formed in the anode, thereby minimizing the delamination of the solid electrolyte interphase in spite of a large volume change during charging and discharging of the secondary battery. Accordingly, the stability of the anode can be further enhanced, thereby enabling long-term stable operation of the anode.

In addition, a difference (β₁-β₂) between the β₁ and the β₂ may be, for example, 0.30 or more, for example, 0.35 or more, for example, 0.40 or more, for example, 0.42 or more, for example, 0.43 or more, or for example, 0.44 or more. Specifically, the difference (β₁-β₂) between the β₁ and the β₂ may be, for example, 0.30 or more to 1.00 or less, for example, 0.35 or more to 1.00 or less, for example, 0.40 or more to 1.00 or less, for example, 0.42 or more to 1.00 or less, for example, 0.44 or more to 1.00 or less, for example, 0.44 or more to 0.90 or less, or for example, 0.44 or more to 0.87 or less. When the difference (β₁-β₂) between the β₁ and the β₂ above satisfies the range above, it may be more advantageous to implement the effect for which the present invention is aimed.

Meanwhile, according to an embodiment of the present invention, a E_{T}^{N} value of the second solvent, which represents the polarizability of the solvent in the Kamlet-Taft parameters, may be 0.15 or more.

In order to have the effect for which the present invention is aimed, the second solvent needs to be well mixed in the electrolyte solution without layer separation, by stabilizing the electrolyte environment, which is dominated by positive and negative ions in the form of dipoles, the E_{T}^{N} value may be an indicator of the extent of mixing of the second solvent in the electrolyte solution.

The E_{T}^{N} value may be obtained by irradiating a specific wavelength of light in the solvent, for example, a wavelength of light of approximately 400 to 700 nm, using a UV spectrometer to measure the maximum absorbance.

For example, a dye (Reichardt's dye), 2,6-Diphenyl-4-(2,4,6-triphenyl-1-pyridinio) phenolate, which is zwitterionic, is added to a solvent (the second solvent, water, and tetramethylsilane (TMS)) to a concentration of 1×10⁻⁴ M. Then, the maximum absorption wavelength (λₘₐₓ) for each solvent is obtained, and the polarizability (value) of the solvent is obtained using Equations 2-1 and 2-2 below.

$${E}_{T} ( 30 ) = \frac{28591}{{λ}_{max}} \qquad [ Equation 2 - 1 ]$$

In Equation 2-1 above,
Amax is the maximum absorption wavelength for the solvent, when 2,6-Diphenyl-4-(2,4,6-triphenyl-1-pyridinio) phenolate is added to the solvent, such as the second solvent, water or tetramethylsilane (TMS), to a concentration of 1×10⁻⁴ M, where 28591 is a constant that is a result value of the product of Planck's constant h, the speed of light c, and the Avogadro's number NA. This is because E_{T}(30) represents the electron transfer energy per mole. Therefore, E_{T}(30) has the constant value above.

$${E}_{T}^{N} = \frac{{E}_{T} ( 30 , solvent ) - {E}_{T} ( 30 , TMS )}{{E}_{T} ( 30 , water ) - {E}_{T} ( 30 , TMS )} \qquad [ Equation 2 - 2 ]$$

In Equation 2-2 above,
E_{T}(30, solvent) is E_{T}(30) when the solvent is the second solvent,
E_{T}(30, water) is E_{T}(30) when the solvent is water, and
E_{T}(30, TMS) is E_{T}(30) when the solvent is tetramethylsilane (TMS).

According to an embodiment of the present invention, the E_{T}^{N} value of the second solvent may be, for example, 0.15 or more, for example, 0.16 or more, for example, 0.15 or more to less than 1.00, for example, 0.15 or more to 0.90 or less, for example, 0.15 or more to 0.80 or less, for example, 0.15 or more to 0.70 or less, for example, 0.15 or more to 0.60 or less, for example, 0.15 or more to 0.50 or less, for example, 0.15 or more to 0.40 or less, for example, 0.15 or more to 0.30 or less, for example, 0.15 or more to 0.25 or less, or for example, 0.15 or more to 0.20 or less. When the E_{T}^{N} value of the second solvent satisfies the numerical range above, the second solvent may be well mixed in the electrolyte solution without layer separation, thereby implementing the effect for which the present invention is aimed.

In particular, according to an embodiment of the present invention, it may be more advantageous to implement the effect for which the present invention is aimed when the second solvent satisfies the β₂ of the Kamlet-Taft parameters representing Lewis basicity of 0.20 or less, and the E_{T}^{N} value representing the polarizability of the solvent is 0.15 or more.

Meanwhile, according to another embodiment of the present invention, a lowest unoccupied molecular orbital (LUMO) energy level of the second solvent may be, for example, more than −1.0 eV to less than 0 eV, for example, −0.95 eV or more to less than 0 eV, for example, −0.95 eV or more to −0.01 eV or less, for example, −0.95 eV or more to −0.05 eV or less, for example, −0.95 eV or more to −0.08 eV or less, for example, −0.95 eV or more to −0.09 eV or less, for example, −0.95 eV or more to −0.10 eV or less, for example, −0.95 eV or more to −0.15 eV or less, for example, −0.95 eV or more to −0.16 eV or less, for example, −0.95 eV or more to −0.17 eV or less, for example, −0.95 e V or more to −0.18 eV or less, for example, −0.95 eV or more to −0.20 eV or less, for example, −0.95 eV or more to −0.30 eV or less, for example, −0.95 eV or more to −0.40 eV or less, for example, −0.95 eV or more to −0.50 eV or less, or for example, −0.90 eV or more to −0.50 eV or less. When the LUMO energy level of the second solvent satisfies the numerical range above, a stable electrolyte solution environment may be maintained without a decrease in the amount of solvent in the electrolyte solution even under sustained charge and discharge due to the high LUMO energy level.

The LUMO energy level of the second solvent is an energy level calculated using the program Gaussian 16, Revision A.03, with the calculation of an extended gaussian type basis, as in Ditchfield, R et al, The Journal of Chemical Physics 54, 724-728 (1971). For example, the LUMO energy level is an energy level calculated by the theory of B3LYP/6-31G+(d,p) level of the density-functional theory (DFT), and Grimme dispersion (D3BJ) and ultrafine integration using the program above (Parr, R. G. & Yang, W. Density-functional theory of atoms and molecules (Oxford Univ. Press [u.a.], 1994). Frisch, M. J. et al. Gaussian 16 Rev. C.01. (2016)).

The second solvent may comprise, for example, one or more species selected from the group consisting of furan, anisole, ethoxybenzene, 1,1,2,2-tetrafluoroethyl-2,2,3,3-tetrafluoropropyl ether, 1,2-difluorobenzene, and fluorobenzene.

According to another embodiment of the present invention, the second solvent may be a non-fluorinated solvent. For example, the second solvent may comprise one or more species selected from the group consisting of furan, anisole, and ethoxybenzene.

In this case, the solvation with lithium ions (Li⁺) does not occur (non-solvation) as in a fluorinated solvent even in a long-term charge and discharge environment, and a stable electrolyte solution environment can be maintained during charge and discharge, especially when an anode comprising lithium metal is used and/or when the anode is used in combination with a cathode as a complete secondary battery, which can provide excellent performance of the secondary battery and furthermore has advantages in terms of cost efficiency.

Meanwhile, according to an embodiment of the present invention, by adjusting the content of the first solvent and the second solvent, an optimal electrolyte solution environment can be maintained to further improve the performance of the secondary battery.

Specifically, the amount of the second solvent may be equal to or greater than the amount of the first solvent.

More specifically, a volume ratio of the first solvent and the second solvent may be, for example, 1:1 to 1:3, for example, 1:1 to 1:2, for example, 1:2 to 1:3, for example, 1:1.5 to 1:2.5, or for example, 1:2. When the volume ratio of the first solvent and the second solvent satisfies the range above, the extent of solvation of lithium ions (Li⁺) may be controlled while reducing the concentration of the electrolyte solution, and when the solvent with the volume ratio above is applied to the secondary battery, a stable solvation structure for which the present invention is aimed may be maintained.

In addition, according to an embodiment of the present invention, the first solvent may be one or more species or two or more species, and the second solvent may be one or more species or two or more species. Specifically, the first solvent may be configured with one species, and the second solvent may be configured with one species. That is, the type of solvent comprised in the electrolyte solution may be two or more species, or three or more species, or more specifically, may be configured with two species, but is not limited thereto.

### [Additives]

The electrolyte solution according to an embodiment of the present invention may comprise additives.

The additives may comprise various conventionally used additives, as long as the additives do not interfere with the effect of the present invention, and may be added by adjusting the content thereof to meet the desired properties and uses.

Specifically, the electrolyte solution may further comprise a nitrate-based compound. For example, the nitrate-based compound may comprise one or more species selected from the group consisting of lithium nitrate (LiNO3), potassium nitrate (KNO₃), cesium nitrate (CsNO₃), magnesium nitrate (MgNO₃), barium nitrate (BaNO₃), lithium nitrite (LiNO₂), potassium nitrite (KNO₂), and cesium nitrite (CsNO₂).

In addition, the additives, for example, such as fluoroethylene carbonate (FEC), vinylene carbonate (VC), vinyl ethyl carbonate (VEC), lithium fluoride (LiF), lithium sulfide (Li₂Sₓ, 2≤x≤8), and lithium bifluoride phosphate (LiPO₂F₂), may be further comprised.

The additives may be comprised in the amount of, for example, more than 0 wt % to 30 wt %, for example, 1 wt % to 30 wt %, or for example, 5 wt % to 20 wt %, based on a total weight of the electrolyte solution. When the content of the additive above is too high, the performance of the secondary battery may even be degraded.

### [Secondary Battery]

According to an embodiment of the present invention, a secondary battery comprising the electrolyte solution may be provided.

The secondary battery may comprise an anode, a cathode, a separator interposed between the cathode and the anode, and an electrolyte solution, in which the electrolyte solution may comprise a lithium salt; a first solvent; and a second solvent, and when the Lewis basicities of the Kamlet-Taft parameters of the first solvent and the second solvent are represented by β₁ and β₂, respectively, in which the β₁ may be 0.40 or more, and the β₂ may be 0.20 or less.

Specifically, the cathode may comprise a cathode current collector and a cathode active material applied to one or both surfaces of the cathode current collector.

The cathode current collector is not particularly limited, provided that the cathode current collector supports the cathode active material and has a high conductivity without causing chemical changes in the secondary battery.

The cathode current collector may be made of, for example, stainless steel, aluminum, nickel, titanium, palladium, calcined carbon, stainless steel or copper surface treated with carbon, nickel, silver, etc., an aluminum-cadmium alloy, or the like.

The cathode current collector may form microscopic irregularities on a surface thereof to strengthen a binding force with the cathode active material, and may use various forms, such as a film, a sheet, a foil, a mesh, a net, a porous structure, a foam, a non-woven fabric, or the like.

The cathode active material may comprise selectively a conductive agent and a binder in addition to the cathode active material.

The cathode active material may comprise, for example, one or more species selected from the group consisting of LiMn₂O₄, V₂O₅, LiCoO₂, LiNiO₂, LiFePO₄, Li₄Ti₅O₁₂. LiNiₓCo_{y}Mn_{z}O₂ (x+y+z=1) and LiNiₓCo_{y}Al_{z}O₂ (x+y+z=1).

The conductive agent is for improving electrical conductivity, and any electronically conductive material that does not cause chemical changes in the secondary battery may be applied without particular limitation.

The conductive agent may be, for example, carbon black, graphite, carbon fiber, carbon nanotubes, metal powder, conductive metal oxide, organic conductive agent, and the like, in which products currently commercialized as the conductive agent may comprise the Acetylene Black series (products of Chevron Chemical Company or Gulf Oil Company, etc.), Ketjen Black EC series (products of Armak Company), Vulcan XC-72 (a product of Cabot Company), and SUPER P, or the like.

Further, the cathode active material may further comprise a binder having the function of fixing the cathode active material to the cathode current collector and linking the active materials. As the binder, for example, various types of binders may be used, for example, polyvinylidene fluoride-hexafluoropropylene (PVDF-co-HFP), poly(vinylidene fluoride) (PVDF), polyacrylonitrile, polymethyl methacrylate, styrene butadiene rubber (SBR), carboxyl methyl cellulose (CMC), poly(acrylic acid) (PAA), poly(vinyl alcohol) (PVA), or the like.

Meanwhile, the anode may comprise an anode current collector and an anode active material positioned on the anode current collector. Alternatively, the anode may comprise a lithium metal thin film.

The anode current collector is for supporting the anode active material, which is not particularly limited as long as the anode active material has good conductivity and is electrochemically stable in the voltage region of the secondary battery. For example, as the anode active material, copper, stainless steel, nickel, titanium, palladium, calcined carbon, copper or stainless steel surface treated with carbon, nickel, silver, etc., aluminum-cadmium alloy, or the like may be used.

The anode current collector may form microscopic irregularities on a surface thereof to strengthen a binding force with the anode active material, and may use various forms, such as a film, a sheet, a foil, a mesh, a net, a porous structure, a foam structure, a non-woven fabric structure, or the like.

The anode active material may comprise a material capable of reversibly intercalating or deintercalating lithium ions (Li⁺), a material capable of reacting with lithium ions to reversibly form a lithium-containing compound, a lithium metal, or a lithium alloy.

The material capable of reversibly intercalating or deintercalating the lithium ions (Li⁺) may be, for example, crystalline carbon, amorphous carbon, or a mixture thereof.

The material that is capable of reacting with the lithium ions (Li⁺) to reversibly form the lithium-containing compound may be, for example, tin oxide, titanium nitrate, or silicon.

The lithium alloy may be an alloy of lithium (Li) with metals comprising, for example, one or more species selected from the group consisting of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al), and tin (Sn).

Specifically, the anode active material may be a lithium metal, preferably in the form of a lithium metal thin film or lithium metal powder.

A method of forming the anode active material is not particularly limited, and any method of forming a layer or film conventionally used in the art may be used. For example, methods such as pressing, coating, or deposition may be used. In addition, the anode of the present invention may also comprise a case where a lithium metal thin film is formed on a metal plate by initial charging after the battery is assembled with no lithium thin film on the current collector.

The electrolyte solution comprises lithium ions, and is for causing an electrochemical oxidation or reduction reaction at the cathode and anode with the lithium ions as a mediator, which is as described above.

An injection of the electrolyte solution may be performed at any proper step in the process of manufacturing an electrochemical device, depending on the manufacturing process and required properties of a final product. That is, the injection of the electrolyte solution may be applied before the electrochemical device assembly or at a final step of the electrochemical device assembly.

Meanwhile, the separator may be further comprised between the cathode and the anode.

The separator is for physically separating the two electrodes in the secondary battery of the present invention, and when used as a separator in a lithium-ion battery, the separator may be used without any particular limitation, and in particular, it is preferable to have a low resistance to the movement of ions in the electrolyte solution and an excellent moisture absorption capacity of the electrolyte solution.

The separator may be made of a porous substrate. The porous substrate may be any porous substrate conventionally used in an electrochemical device, for example, a polyolefin-based porous membrane or non-woven fabric, but is not particularly limited thereto.

An example of the polyolefin-based porous membrane may be a membrane formed from a polymer comprising polyethylene, such as high-density polyethylene, linear low-density polyethylene, low-density polyethylene, or ultra-high molecular weight polyethylene, and a polyolefin-based polymer, such as polypropylene, polybutylene, or polypentene, either individually or in a mixture thereof.

The non-woven fabric may comprise, in addition to the polyolefin-based non-woven fabric, a non-woven fabric formed from a polymer comprising, for example, polyethyleneterephthalate, polybutyleneterephthalate, polyester, polyacetal, polyamide, polycarbonate, polyimide, polyetheretherketone, polyethersulfone, polyphenyleneoxide, polyphenylenesulfide, and polyethylenenaphthalate, each individually or in a mixture thereof. A structure of the non-woven fabric may be a spunbonded non-woven fabric or a melt-blown non-woven fabric composed of filament fibers.

A thickness of the porous substrate is not particularly limited, but may be 1 to 100 μm, or 5 to 50 μm.

A size and porosity of pores present in the porous substrate is also not particularly limited. For example, the size of the pores present in the porous substrate may be 0.001 to 50 μm, and the porosity may be 10 to 95%.

The secondary battery according to the present invention is capable of performing not only winding, which is a conventional process, but also processes of lamination, stacking and folding of the separator and electrodes.

A shape of the secondary battery is not particularly limited and may comprise various shapes such as a cylindrical shape, a stacked shape, a coin shape, and the like.

In addition, the secondary battery according to an embodiment of the present invention may last for 120 cycles or more at a charge and discharge rate of 0.2 C-rate.

The secondary battery according to an embodiment of the present invention can improve the life characteristics of the secondary battery by comprising the electrolyte solution.

### [Battery Module]

According to an embodiment of the present invention, a battery module including the secondary battery as a unit cell may be provided.

The battery module may be used as a power source for medium to large devices that require high temperature stability, long cycle characteristics, and high capacity characteristics.

Examples of the medium to large devices may comprise a power tool driven by a battery-powered motor; an electric vehicle, including an electric vehicle (EV), a hybrid electric vehicle (HEV), a plug-in hybrid electric vehicle (PHEV), and the like; an electric two-wheeler, including an electric bicycle (E-bike), an electric scooter (E-scooter); an electric golf cart; and a power storage system, but are not limited thereto.

The aforementioned is further described in the following examples.

However, the following examples are intended to illustrate the present invention, and the scope of the present invention is not limited to these examples.

### <Example 1> Preparation of Electrolyte Solution and Secondary Battery 1

As the lithium salt, LiFSI were prepared. In addition, 1,2-dimethoxyethane (DME) with the β₁ of 0.62, which represents the Lewis basicity of the Kamlet-Taft parameters, was prepared as the first solvent, and anisole with the β₂ of 0.18, which represents the Lewis basicity of the Kamlet-Taft parameters, was prepared as the second solvent.

A mixed solvent in which the first solvent and the second solvent were mixed in a volume ratio of 1:2 was mixed with 3.0 mol of LiFSI per total volume L of the mixed solvent to prepare an electrolyte solution.

In the preparation of the secondary battery, a LiFePO₄ electrode with a thickness of 90 μm was used as a cathode (LFP), a lithium metal thin film with a thickness of 20 μm was used as an anode (Li). In this case, the cathode (LFP) is an electrode in which LiFePO₄ as a cathode active material, Super P as a conductive agent, and poly(vinylidene fluoride) (PVDF) as a binder are mixed in a weight ratio of 93.5:4:2.5 to make a slurry that is then cast on an aluminum foil of 20 μm as a current collector.

After positioning the prepared cathode and anode to face each other and interposing a polyethylene separator therebetween, the secondary battery was prepared by injecting the electrolyte solution of 80 [symbol] .

### <Example 2> Preparation of Electrolyte Solution and Secondary Battery 2

The electrolyte solution and the secondary battery using the electrolyte solution were prepared in the same manner as in Example 1, except that the second solvent with β₂ of 0.17 was used.

### <Example 3> Preparation of Electrolyte Solution and Secondary Battery 3

The electrolyte solution and the secondary battery using the electrolyte solution were prepared in the same manner as in Example 1, except that the second solvent with β₂ of 0.12 was used, and 1.0 mol of LiFSI was used per total volume L of the mixed solvent of the first solvent and the second solvent.

### <Example 4> Preparation of Electrolyte Solution and Secondary Battery 4

The electrolyte solution and the secondary battery using the electrolyte solution were prepared in the same manner as in Example 1, except that the second solvent with β₂ of −0.25 was used.

### <Example 5> Preparation of Electrolyte Solution and Secondary Battery 5

The electrolyte solution and the secondary battery using the electrolyte solution were prepared in the same manner as in Example 1, except that the second solvent with β₂ of 0.02 was used.

### <Example 6> Preparation of Electrolyte Solution and Secondary Battery 6

The electrolyte solution and the secondary battery using the electrolyte solution were prepared in the same manner as in Example 1, except that the second solvent with β₂ of 0.04 was used.

### <Example 7> Preparation of Electrolyte Solution and Secondary Battery 7

The electrolyte solution and the secondary battery using the electrolyte solution were prepared in the same manner as in Example 1, except that the second solvent with β₂ of 0.12 was used, and 2.0 mol of LiFSI was used per total volume L of the mixed solvent of the first solvent and the second solvent.

### <Comparative Example 1> Preparation of Electrolyte Solution and Secondary Battery 8

The electrolyte solution and the secondary battery using the electrolyte solution were prepared in the same manner as in Example 1, except that the second solvent with β₂ of 0.55 was used.

### <Comparative Example 2> Preparation of Electrolyte Solution and Secondary Battery 9

The electrolyte solution and the secondary battery using the electrolyte solution were prepared in the same manner as in Example 1, except that the first solvent with β₁ of 0.18 and the second solvent with β₂ of −0.25 was used.

### <Experimental Example 1> Lewis Basicity (β (β₁, β₂)) of Kamlet-Taft Parameter

The Lewis basicity of the Kamlet-Taft parameters was obtained by measuring the absorbance in the wavelength region of approximately 300 to 500 nm using a Shimadzu UV-2600 spectrometer.

Specifically, the maximum absorption wavelength λₘₐₓ₍₄₎ was obtained by adding 4-nitroaniline to a concentration of approximately 1×10⁻⁴ M, and the maximum absorption wavelength λₘₐₓ₍ₙ₎ was respectively obtained by adding N,N-diethyl-4-nitroaniline to a concentration of 1×10⁻⁴ M, to a solvent (the first solvent or the second solvent) in which the (β (β₁, β₂)) value is to be measured.

After converting the above λₘₐₓ₍₄₎ and λₘₐₓ₍ₙ₎ to a unit of kK (kilokaiser, 1 kK=1000 cm⁻¹), respectively, the Lewis basicity (β (β₁, β₂)) was obtained using Equations 1-1 and 1-2 below.

$${λ}_{max ( N ) (} kK ) = {λ}_{max ( n ) (} kK ) \times 1.035 + 2.64 \qquad [ Equation 1 - 1 ]$$

In Equation 1-1 above,
The λₘₐₓ₍ₙ₎ is the maximum absorption wavelength (λₘₐₓ₍ₙ₎) measured at a concentration of 1×104 M of a mixed solution of the solvent and N,N-diethyl-4-nitroaniline, and 1.035 and 2.64 above are a slope and a y-intercept obtained by first-order linear regression of λₘₐₓ₍₄₎ and λₘₐₓ₍ₙ₎, in which the maximum absorption wavelength (λₘₐₓ₍₄₎) is obtained by adding 4-nitroaniline to a concentration of approximately 1×10⁻⁴ M to various types of nonpolar solvents, and the maximum absorption wavelength (λₘₐₓ₍ₙ₎) is obtained by adding N,N-diethyl-4-nitroaniline to a concentration of 1×10⁻⁴ M to various types of nonpolar solvents, respectively.

$$β = \frac{{λ}_{max ( N ) -} {λ}_{max ( 4 )}}{2.8} \qquad [ Equation 1 - 2 ]$$

In Equation 1-2 above,
The λ_{max(N)} is as defined in Equation 1-1, and the λₘₐₓ₍₄₎ is the maximum absorption wavelength (λₘₐₓ₍ₙ₎) measured at a concentration of 1×10⁻⁴ M of a mixed solution of the solvent and 4-nitroaniline.

### <Experimental Example 2> Polarizability (E_{T}^{N} Value) of Solvent

The polarizability of a solvent (E_{T}^{N} value) of the Kamlet-Taft parameters was obtained by measuring the absorbance in the wavelength region of approximately 400 to 700 nm using a Shimadzu UV-2600 spectrometer.

Specifically, a dye (Reichardt's dye), 2,6-Diphenyl-4-(2,4,6-triphenyl-1-pyridinio) phenolate, which is zwitterionic, was added to the solvent (the second solvent, water, and tetramethylsilane (TMS)) to a concentration of 1×10⁻⁴ M. Then, the maximum absorption wavelength (λmax) for each solvent was obtained.

The polarizability (E_{T}^{N} value) of each solvent above was obtained using the maximum absorption wavelength (λmax) for each solvent, using Equations 2-1 and 2-2 below.

$${E}_{T} ( 30 ) = \frac{28591}{{λ}_{max}} \qquad [ Equation 2 - 1 ]$$

In Equation 2-1 above,
λₘₐₓ is the maximum absorption wavelength for the solvent, when 2,6-Diphenyl-4-(2,4,6-triphenyl-1-pyridinio) phenolate is added to the solvent, such as the second solvent, water or tetramethylsilane (TMS), to a concentration of 1×10⁻⁴ M,

$${E}_{T}^{N} = \frac{{E}_{T} ( 30 , solvent ) - {E}_{T} ( 30 , TMS )}{{E}_{T} ( 30 , water ) - {E}_{T} ( 30 , TMS )} \qquad [ Equation 2 - 2 ]$$

In Equation 2-2 above,
E_{T}(30, solvent) is E_{T}(30) when the solvent is the second solvent, E_{T}(30, water) is E_{T}(30) when the solvent is water, and E_{T}(30, TMS) is E_{T}(30) when the solvent is tetramethylsilane (TMS).

### <Experimental Example 3> LUMO Energy Level

The LUMO energy level is an energy level calculated by the theory of B3LYP/6-31G+(d,p) level of the density-functional theory (DFT), and Grimme dispersion (D3BJ) and ultrafine integration using Gaussian 16, Revision A.03 program (Parr, R. G. & Yang, W. Density-functional theory of atoms and molecules (Oxford Univ. Press [u.a.], 1994). Frisch, M. J. et al. Gaussian 16 Rev. C.01. (2016).

### <Experimental Example 4> Evaluation of Charge and Discharge and Life (Cycle) Characteristics of Secondary Battery

The evaluation of charge and discharge rate was performed in a manner in which each of the secondary batteries according to Examples 1 to 7, Comparative Examples 1 and 2 was charged to a voltage of 3.8 V at a C-rate of 0.1 C, 0.25 C, 0.5 C, 0.75 C, 1 C, 2 C, and 3 C, sequentially for 5 cycles, and discharged to a voltage of 2.0 V at the same C-rate.

After the performing, the characteristic of charge and discharge of the secondary battery was evaluated in a manner in which how much discharge capacity was maintained compared to 0.1 C at high C-rate was compared for each electrolyte solution, and the life characteristic (%) of the secondary battery was calculated, which is represented by [Equation A] below:

$$Life characteristic of secondary battery ( \% ) = discharge capacity at {120}^{th} cycle / discharge capacity at first cycle \times 100 ( \% ) \qquad [ Equation A ]$$

The results obtained from the evaluation examples 1 to 4 above are summarized in Table 1 below.

TABLE 1

| | Electrolyte solution | | | | | | |
|---|---|---|---|---|---|---|---|
| | | Second solvent | | | | Secondary battery | |
| | | | | LUMO | First | Life | |
| | First | | | Energy | solvent:Second | characteristic | |
| | solvent | | E_{T}^{N} | level | solvent | of secondary | |
| Classification | β₁ | β₁ | value | (eV) | (Volume ratio) | battery (%) | Life (cycle) characteristic |
| Example 1 | 0.62 | 0.18 | 0.198 | −0.584 | 1:2 | 91.03% | Last more than 120 cycles |
| | | | | | | | with 0.2 C charge and |
| | | | | | | | discharge |
| Example 2 | 0.62 | 0.17 | 0.182 | −0.572 | 1:2 | 85.17% | Last more than 120 cycles |
| | | | | | | | with 0.2 C charge and |
| | | | | | | | discharge |
| Example 3 | 0.62 | 0.12 | 0.164 | −0.186 | 1:2 | 94.57% | Last more than 120 cycles |
| | | | | | | | with 0.2 C charge and |
| | | | | | | | discharge (1M |
| | | | | | | | concentration) |
| Example 4 | 0.62 | −0.25 | 0.77 | −0.082 | 1:2 | 90.60% | Last more than 120 cycles |
| | | | | | | | with 0.2 C charge and |
| | | | | | | | discharge |
| Example 5 | 0.62 | 0.02 | 0.265 | −0.0865 | 1:2 | 66.14% | Last more than 120 cycles |
| | | | | | | | with 0.2 C charge and |
| | | | | | | | discharge |
| Example 6 | 0.62 | 0.04 | 0.194 | −0.769 | 1:2 | 86.72% | Last more than 120 cycles |
| | | | | | | | with 0.2 C charge and |
| | | | | | | | discharge |
| Example 7 | 0.62 | 0.12 | 0.164 | −0.186 | 1:2 | 94.27% | Last for more than 120 |
| | | | | | | | cycles with 0.2 C charge |
| | | | | | | | and discharge (2M |
| | | | | | | | concentration) |
| Comparative | 0.62 | 0.55 | 0.167 | −0.303 | 1:2 | — | Cycling not possible using |
| Example 1 | | | | | | | LFP |
| Comparative | 0.18 | −0.25 | 0.760 | −0.440 | 1:2 | — | Unable to manufacture full |
| Example 2 | | | | | | | cell due to electrolyte layer |
| | | | | | | | separation |

As can be seen from Table 1 above, it was confirmed that the secondary batteries of Examples 1 to 7 with the electrolyte solution satisfying Bi of the first solvent of 0.40 or more and β₂ of the second solvent of 0.20 or less had excellent life characteristics, as the ratio of the discharge capacity in the first cycle to the discharge capacity in the 120th cycle was mostly 85% or more, and lasted for more than 120 cycles with 0.2 C charge and discharge.

In contrast, even though the β₁ of the first solvent satisfies 0.40 or more, cycling using LFP was not possible for the secondary battery according to Comparative Example 1 with the electrolyte solution with the β₂ of the second solvent of 0.55, and in case of Comparative Example 2, which applied the electrolyte solution with the β₁ of the first solvent as low as 0.18, even though the β₂ of the second solvent satisfied 0.20 or less, it was impossible to analyze the performance of the secondary battery because it was impossible to manufacture a full cell due to the separation of the electrolyte layer.

From the results above, it was confirmed that in case of the electrolyte solution according to Examples 1 to 7 of the present invention, an inorganic-based solid electrolyte interphase with strong electrochemical activity is formed on the anode, which enables a long-term stable operation of the anode, thereby improving the performance of the secondary battery.

1. An electrolyte solution comprising:
a lithium salt;
a first solvent; and
a second solvent,
wherein when Lewis basicities of Kamlet-Taft parameters of the first solvent and the second solvent are represented by β₁ and β₂, respectively, the β₁ is 0.40 or more, and the β₂ is 0.20 or less.

2. The electrolyte solution of claim 1, wherein a volume ratio of the first solvent and the second solvent is 1:1 to 1:3.

3. The electrolyte solution of claim 1, wherein a difference (β₁-β₂) between the β₁ and the β₂ is 0.30 or more.

4. The electrolyte solution of claim 1, wherein the first solvent comprises one or more species selected from the group consisting of an ether-based solvent, an ester-based solvent, a linear carbonate-based solvent, a cyclic carbonate-based solvent, and an amide-based solvent.

5. The electrolyte solution of claim 1, wherein the β₂ is-0.25 to 0.20.

6. The electrolyte solution of claim 1, comprising a solvent having E_{T}^{N} value of 0.15 or more, which represents a polarizability of a solvent, of the Kamlet-Taft parameters of the second solvent.

7. The electrolyte solution of claim 1, wherein the second solvent has a lowest unoccupied molecular orbital (LUMO) energy level of more than −1.0 eV to less than 0 eV.

8. The electrolyte solution of claim 1, wherein the second solvent comprises one or more species selected from the group consisting of furan, anisole, ethoxybenzene, 1,1,2,2-tetrafluoroethyl-2,2,3,3-tetrafluoropropyl ether, 1,2-difluorobenzene, and fluorobenzene.

9. The electrolyte solution of claim 1, wherein the second solvent is a non-fluorinated solvent.

10. The electrolyte solution of claim 1, wherein the lithium salt comprises one or more species selected from the group consisting of LiPF₆, LiAsF₆, LiFSI, LiTFSI, LiCF₃SO₃, LiN(CF₃SO₂)₂, LiBF₄, LiBF₆, LiSbF₆, LIN(C₂F₅SO₂)₂ and LiSO₃CF₃.

11. The electrolyte solution of claim 1, wherein the electrolyte solution comprises 1 to 8 mol of the lithium salt based on a total volume of the first solvent and the second solvent.

12. A secondary battery comprising:
an anode;
a cathode;
a separator interposed between the cathode and the anode; and
an electrolyte solution,
wherein the electrolyte solution comprises:
a lithium salt;
a first solvent; and
a second solvent, and
wherein when Lewis basicities of Kamlet-Taft parameters of the first solvent and the second solvent are represented by β₁ and β₂, respectively, the β₁ is 0.40 or more, and the β₂ is 0.20 or less.
